(19) United States
(12) Patent Application Publication
(10) Pub. No.: US 2006/0144652 A1
(43) Pub. Date: Jul. 6, 2006

(54) Disc brake with an adjustment device in particular for a commercial vehicle

(76) Inventors: Josef Wimmer, Vilshofen (DE); Michael Hidringer, Hofkirchen (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/534,999

(22) PCT Filed: Nov. 17, 2003
(86) PCT No.: PCT/EP03/12841

§ 371 Date: Dec. 20, 2005

(30) Foreign Application Priority Data
Nov. 18, 2002 (DE) 102536422

(51) Int. Cl. F16D 65/40

(52) U.S. Cl. 188/73.38

(57) ABSTRACT

The invention relates to a disc brake, in particular for a commercial vehicle, comprising a brake caliper (2), enclosing a brake disc (2), fixed to a brake support (6) such as to be axially displaced with relation to the brake disc (1), with an actuation device (11), arranged to the one side thereof, having a displacing element, in particular a cross-piece (10) with at least one threaded drilling (16), into which an adjusting spindle (12) is screwed which supports a pressure piece (13) by means of which the brake pad (9) may be pressed against the brake disc (1), an adjuster device, cooperating with the adjuster spindle (12), by means of which a wear-related change in the play between the brake pad (9) and the brake disc (1) can be essentially compensated for and a security element acting on the adjustment spindle to limit rotation until a certain torque is achieved, embodied such that the security element comprises a spring ring (14) which lies in an annular groove (15) on the threaded drilling (16) or the adjuster spindle (12) and rests with a spring pressure on the opposing thread.

### BACKGROUND AND SUMMARY OF THE INVENTION

The present invention relates to a disc brake, particularly for a commercial vehicle, having a caliper that straddles a brake disc, which caliper, relative to the brake disc is axially displaceably fastened to a brake anchor plate and on whose one side, a brake application device is arranged. The brake application device has a displaceable element, particularly a transverse beam, which has at least one threaded bore into which an adjusting screw, which carries a pressure piece, is screwed by which a brake pad can be pressed against the brake disc. The brake application device has an adjusting device, which is in an operative connection with the adjusting screw, by which adjusting device a wear-caused change of a release play between the brake pad and the brake disc can essentially be compensated. The brake application device further has a protection element, which has a rotation-inhibiting effect on the adjusting screw up to a certain torque.

In the case of such a disc brake, which is known, for example, from German Patent document DE 94 22 342 U1 and which is normally pneumatically operable, the brake application device is coupled with a transverse beam in which preferably two adjusting screws are disposed, which each have a pressure piece for receiving a brake pad pressed against a brake disc in the event of a braking operation.

The two adjusting screws are equipped with an external thread and are screwed into a respective assigned threaded bore of the transverse beam.

By means of an adjusting device, which is assigned to an adjusting screw and a driving dog of the other adjusting screw, in the event of brake pad wear, the brake pad is applied to such as extent by rotating the adjusting screws in the threaded bores that a release play between the brake pad and the brake disc essentially always remains constant.

In order to prevent that, as a result of shocks or vibrations during the traveling operation, the adjusting screws change their position and, thus, the distance between the brake pad and the disc brake, thus the release play, protection elements are used which have a rotation-inhibiting effect on the adjusting screws, so that the above-mentioned unintended adjusting of the adjusting screws is prevented. In this case, the protection devices rest frictionally against the adjusting screw or against parts thereof.

The frictional force is proportioned such that, at a certain torque to be applied by the adjusting device, the adjusting screws can be rotated without any problem, in which case this torque is greater than a torque that may result from the shock forces in the traveling operation.

A known protection device consists of a secondary seal, which is arranged in the end area of an adjusting screw facing the pressure piece and engages in a protective manner in the adjusting screw.

Among other things, for the function of the rotational inhibition, the secondary seal or the part engaging in the adjusting screw consists of a plastic material, which may be detrimentally affected mainly by the friction heat occurring during braking.

In the same manner, this applies to a sleeve also consisting of a plastic material, by which a pressure spring can be prestressed and which, on the other side, is supported on the above-mentioned driving dog of the second adjusting screw, whereby a rotational inhibition is achieved in this area.

As a result of the construction-caused different interventions in the sense of a rotational inhibition of the two protection elements, in addition, an adjustment of the coefficient of friction, which is the same for both protection elements is virtually impossible, which can also lead to problems during the adjusting as well as for the protection of the two adjusting screws.

It is therefore an object of the present invention to further develop a disc brake of the above-mentioned type such that, by constructively simple devices, the reliability of the rotational inhibition of the adjusting screw is improved and the operating reliability as a whole is increased.

This object is achieved by means of a disc brake having a caliper that straddles a brake disc, which caliper, relative to the brake disc, is axially displaceably fastened to a brake anchor plate and on whose one side, a brake application device is arranged. The brake application device has a displaceable element, particularly a transverse beam, which has at least one threaded bore into which an adjusting screw, which carries a pressure piece, is screwed by which a brake pad can be pressed against the brake disc. The brake application device has an adjusting device, which is in an operative connection with the adjusting screw, by which adjusting device a wear-caused change of a release play between the brake pad and the brake disc can essentially be compensated. The brake application device further has a protection element, which has a rotation-inhibiting effect on the adjusting screw up to a certain torque. The protection element includes a spring ring, which is disposed in a ring groove of the threaded bore or the adjusting screw and is elastically supported on the opposite thread.

Inside the threaded bore, or the engaging area of the threaded screw, in the thread of the threaded bore, the arrangement of the protection element in the form of a spring ring is essentially freely selectable, so that the spring ring can be placed outside an area acted upon by the heat that occurs during braking. As a result, material-damaging influences can virtually no longer occur or can occur only to an insignificant degree, whereby a protection is obtained, which is considerably improved in comparison to the prior art.

The spring ring advantageously consists of metal instead of plastic, as previously used. Because of the insensitivity of the metal with respect to heat in contrast to the previously used plastic material, the protection element can virtually be provided at any suitable point of the operating area without resulting in service life disadvantages. Furthermore, the wear of the protection element caused by the frictional forces having the rotation-inhibiting effect is also negligibly low so that, on the whole, a significant improvement of the operating reliably is obtained in the continuous operation.

Since precise positioning of the protection elements now become possible as well as exactly the same construction, particularly with respect to the material and the shape of the spring rings, an equally large clamping torque becomes operative for both adjusting screws.

The clamping effect itself can be defined, specifically by the type and construction of the spring rings, as well as by the defined mounting position between the components to be braced.

The rotational inhibition of the threaded screws takes place uniformly over the entire circumference without an attack on the thread flanks, whereby a gentle clamping is obtained.

The required clamping force of the spring ring can be achieved by geometrical changes but also by a corresponding selection of the material and can be exactly predefined.

According to another aspect of the invention, it is provided that the spring ring is designed with an undulated contour, so that one portion—forming radially aligned summits—rests against the bottom of the ring groove and the other portion rests against the thread of the assigned component, thus of the adjusting screw or of the threaded bore.

Since the spring ring is in frictional contact over the entire circumference, an antitwist protection for the spring ring is not necessary.

In addition, the manufacturing of the spring ring, its mounting, as well as the placement of the spring groove can take place in a very simple and cost-effective manner. An exchange of the spring ring is also very easy so that, on the whole, an optimization can take place with respect to costs, which is particularly advantageous in view of the fact that such disc brakes are used in large piece numbers.

Additional advantageous further developments of the invention are described and claimed herein.

Embodiments of the invention will be described in the following by means of the attached drawings.

### BRIEF DESCRIPTION OF THE DRAWINGS

FIG. 1 is a partially sectional top view of a disc brake according to the invention;

FIG. 2 is a perspective view of a detail of the disc brake;

FIG. 3 also is a perspective view of a protection element according to the invention.

### DETAILED DESCRIPTION OF THE DRAWINGS

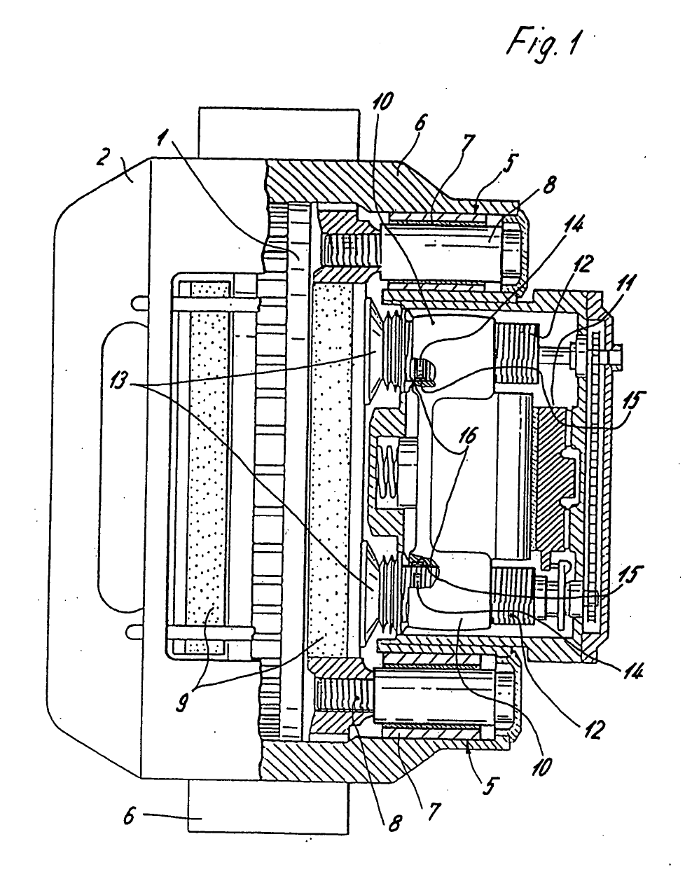

FIG. 1 illustrates a disc brake, particularly for a commercial vehicle, which has a caliper 2 in its basic construction. The caliper 2 straddles a ventilated brake disc 1, which is fastened to an axle of the commercial vehicle (which is not shown).

Relative to the brake disc 1, the caliper 2 is axially displaceably fastened to a brake anchor plate 6 of the commercial vehicle.

For this purpose, fastening elements 5 are provided, which each have a guide bush 7 as well as a guiding strut 8.

The guide bushes 7 are immovably connected with the caliper 2, while the guiding struts 8 are screwed into the brake anchor plate 6 so that the guide bushes 7 together with the caliper 2 are axially displaceably disposed on the guiding struts 8, which to this extent are stationary.

As also illustrated in FIG. 1, the brake disc 1 can be brought into an operative connection with brake pads 9 for the purpose of braking. For this purpose, the brake pads 9 are pressed against the brake disc 1 during braking.

For triggering a braking operation, a brake application device 11 is arranged on one side of the caliper 2. The present embodiment shows only a part of this brake application device 11, which is connected to a transverse beam 10.

Two parallel adjusting screws 12, which are spared apart at a distance from one another, have an external thread and carry one pressure piece 13, respectively, and are screwed into the traverse 10. At one end of the adjusting screws 12, one of the two brake pads 9 is fastened thereto.

By using an adjusting device, which is not shown and which is coupled with at least one of the two adjusting screws 12, it is achieved during each operation of the brake application device 11 that the release play, which changes due to brake pad wear, remains constant; that is, the adjusting screws 12 are correspondingly axially displaced by rotation to compensate for the wear.

In this case, the rotation of one adjusting screw 12 caused by the adjusting device can be transmitted by a synchronization device to another adjusting screw, so that the latter is rotated by the same angular amount with the result that both adjusting screws 12 are moved by exactly the same axial distance.

In order to prevent that, in the travelling operation, for example, as a result of shocks or vibrations, the adjusting screws 12 rotate in an unintended manner and the release play is thereby changed in a correspondingly unintended manner, protection devices are, in each case, provided in the form of a spring ring 14, which rests in a rotation-inhibiting manner either against the thread of the adjusting screw 12 or the threaded bore 16.

Both embodiments are illustrated in FIG. 1. In this case, it is shown that the upper adjusting screw 12 (relative to FIG. 1) has a surrounding ring groove 15 in which the spring ring 14 is disposed. In contrast, the ring groove 15 is formed in the area of the lower adjusting screw 12 by a recess in the threaded bore 16 in which the spring ring 14 is disposed and rests frictionally on the external thread of the adjusting screw 12.

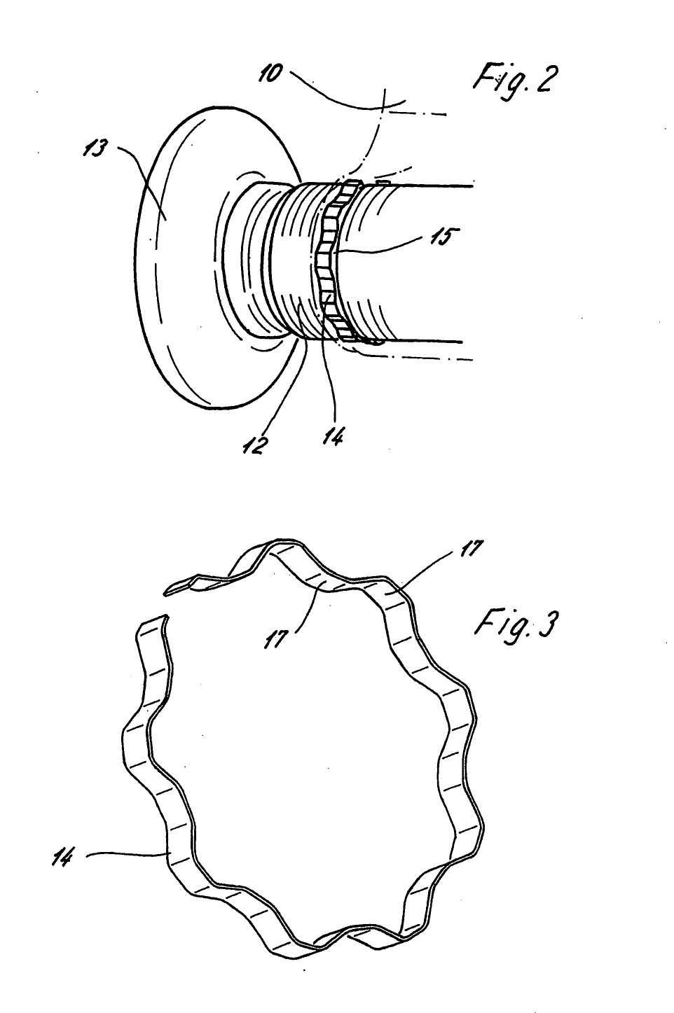

FIG. 2 shows an enlarged representation, as a schematic cutout, of the transverse beam 10, this representation corresponds to the area of the lower adjusting screw 12 according to FIG. 1.

As in FIG. 3, it is illustrated here that the spring ring 14 has an undulated contour whose summits 17 alternately rest on the bottom of the spring groove 15 and on the external thread of the adjusting screw 12.

As further illustrated in FIG. 3, the spring ring 14, which is preferably shaped from a strip of steel plate, is slotted, so that spring forces can be radially effective.

In addition to the illustrated shape of the spring ring 14, other shapes, particularly other contours, are naturally contemplated.

The ring groove 15, which preferably extends without a slope, is adapted in its width to the width of the spring ring 14, so that the latter rests in it in an axial-displacement-proof manner.

### TABLE OF REFERENCE NUMBERS

1 brake disc
2 caliper
5 fastening element
6 brake anchor plate
7 guide bush
8 guiding strut
9 brake pad
10 transverse beam
11 brake application device
12 adjusting screw
13 pressure piece
14 protection element
15 ring groove
16 threaded bore
17 peak

1-10. (canceled)

11. A disc brake for use with a brake disc, comprising:
an axially slideable caliper which straddles the brake disc when in use;
a brake application device arranged in the caliper on one side of the brake disc, the brake application device comprising a transverse beam having at least one threaded bore into which an adjusting screw carrying a pressure piece is threaded, the brake application device being configured to press a brake pad against the brake disc when in use;
wherein the brake application device further comprises an adjusting device operatively coupled with the adjusting screw, the adjusting device adjusting for a change in a release play between the brake pad and the brake disc; and
further wherein the brake application device comprises a spring ring disposed in a ring groove formed in one of the threaded bore and the adjusting screw, the spring ring being elastically supported on an opposite thread so as to provide a rotation-inhibiting effect on the adjusting screw up to a defined torque.

12. The disc brake according to claim 11, wherein the spring ring is formed of metal.

13. The disc brake according to claim 12, wherein the spring ring is formed as a steel spring.

14. The disc brake according to claim 11, wherein the spring ring has an undulated contour.

15. The disc brake according to claim 12, wherein the spring ring has an undulated contour.

16. The disc brake according to claim 11, wherein the spring ring is shaped from a strip-shaped spring material.

17. The disc brake according to claim 12, wherein the spring ring is shaped from a strip-shaped spring material.

18. The disc brake according to claim 11, wherein the ring groove is constructed without sloping walls.

19. The disc brake according to claim 11, wherein the ring groove has a width corresponding approximately to a width of the spring ring.

20. The disc brake according to claim 11, wherein the spring ring is defined in accordance with a clamping force to be applied to the adjusting screw via its geometry, dimensioning and material selection.

21. The disc brake according to claim 11, wherein the transverse beam includes two threaded bores arranged in parallel to one another and into which respective adjusting screws are threaded; wherein each adjusting screw is assigned a corresponding spring ring.

22. The disc brake according to claim 21, wherein the corresponding spring rings have an identical shape, material and dimensioning.

23. The disc brake according to claim 11, wherein the disc brake is for a commercial vehicle.

24. A brake application device for use in a caliper of a disc brake, comprising:
a transverse beam having a first threaded bore;
a threaded adjusting screw which screws into the first threaded bore;
a wear adjustment device operatively coupled with the adjusting screw for use in compensating wear of the disc brake;
a ring groove formed in either the first threaded bore or the threaded adjusting screw; and
a spring ring disposed in the ring groove so as to be elastically supported on an opposing thread of either of the first threaded bore or the threaded adjusting screw, the spring ring providing a rotation-inhibiting effect on the threaded adjusting screw up to a defined torque.

25. The brake application device according to claim 24, wherein the spring ring is a metal spring ring.

26. The brake application device according to claim 25, wherein the metal spring ring is made of steel spring.

27. The brake application device according to claim 24, wherein the spring ring has an undulating contour about its circumference.

28. The brake application device according to claim 25, wherein the spring ring has an undulating contour about its circumference.

29. The brake application device according to claim 25, wherein the metal spring ring is shaped from a strip-shaped metal spring material.

30. The brake application device according to claim 24, wherein the ring groove has side walls extending parallel to one another and oriented transversely with respect to an axis of the first threaded bore for the threaded adjusting screw, such that the ring groove has no slope.

31. The brake application device according to claim 24, wherein the ring groove has a width corresponding approximately to a width of the spring ring.

32. The brake application device according to claim 24, further comprising a second threaded bore and a second threaded adjusting screw threaded therein, wherein a second ring groove and a second spring ring are assigned to provide the rotation-inhibiting effect on the second threaded adjusting screw.
